(19) United States
(12) Patent Application Publication
(10) Pub. No.: US 2005/0081173 A1
(43) Pub. Date: Apr. 14, 2005

(54) IC design planning method and system

(76) Inventor: Olivier Peyran, Singapore (SG)

Correspondence Address: COHEN & GRIGSBY, P.C., 11 STANWIX STREET, 15TH FLOOR, PITTSBURGH, PA, 15222, US

(21) Appl. No.: 10/685,211

(22) Filed: Oct. 14, 2003

(51) Int. Cl. G06F 9/45

(52) U.S. Cl. 716/9; 716/10

(57) ABSTRACT

An IC design planning method and a system thereof for providing minimized path delay and routing congestion of an IC design are disclosed. The IC design planning system includes a sub-block decoder that is capable of decoding sub-block level information and explicitly consider critical paths of sub-blocks in the sub-block placement and pin positioning processes within a block. The sub-block placement process involves calculating sub-block placement parameters such as weight, center of mass and orientation of a critical pin set of each sub-block for deciding on the order of sub-block selection and placement. The pin positioning process involves finding a preferred pin position for positioning each pin on the boundaries of the sub-blocks.

### FIELD OF THE INVENTION

This invention relates generally to design automation. In particular, it relates to an integrated circuit (IC) design planning method and a system thereof for automatically optimizing chip level design planning of ICs.

### BACKGROUND

As semiconductor technology advances, the space requirement of IC chips is reduced and the number of transistors in the IC chips is increased. Traditional approaches to IC design are no longer able to cope with the challenge of producing IC chips with small footprint and high transistor count while satisfying a number of competing criteria. The criteria include minimizing layout area, routing congestion, and path delay, and achieving a target aspect ratio for the IC chip. A modern approach to IC design is to partition an IC design into a hierarchy of manageable blocks, where each block in the IC design performs one or more specific functions.

Once an IC design is completed and partitioned into blocks, the arrangement or placement of the blocks within a layout area is optimized to satisfy the various competing criteria. A commonly used method for optimizing block placement is simulated annealing. Simulated annealing requires substantially long computational time to provide highly optimized result, especially for complex IC designs, which is undesirable. Many block placement heuristics have been proposed for shortening the computational time. However, these heuristics are usually greedy algorithms and often fail to generate highly optimized results, especially for complex IC designs.

Another typically employed method used for finding optimal solutions is known as genetic algorithm (GA). GA is commonly used in IC chip floor planning for finding and evaluating the possible solutions of placing large number of fixed-size blocks to optimize layout area. The GA is an evolutionary process, which uses fixed length character strings to represent genetic information defining a set or population of individual solutions that can undergo evolutionary changes to produce optimal solutions. An example of a typical block placement using the GA 100 (hereinafter referred to as GA 100) is shown in FIG. 1. The GA 100 begins by generating gene strings to provide an initial population gene strings for processing in a step 102. The gene strings can be considered to constitute inverse Polish expressions each of which describes a slicing tree of a floor plan of an IC chip. For example, a floor plan having b blocks can have an inverse Polish expression of length 2b−1 over the characters {0, 1, . . . , b−1, +, *}, where the operands 1, 0, . . . , b−1 denote block identities of the b blocks and +, * are operators with + and * denoting a horizontal block partition and a vertical block partition, respectively. Information pertaining to each block is typically provided by a user in two separate files: “*.cel” file and “*.net” file. The “*.cel” file contains information such as area, aspect ratio, number of pins, pin positions, and functional description of each block. The “*.net” file contains interconnection relationships between the blocks (nets) and timing budget of critical paths.

Once the initial population is obtained, the GA 100 performs operations on the gene strings to provide a child string in a step 104. The child string is created by a crossover operation, which involves exchanging parts of a string between two parent strings of the previous generation. The child string can also be generated by a mutation operation wherein small random adjustments are made to the parent strings.

The child string is subsequently evaluated or decoded in a step 106 to obtain a fitness score. The fitness score of the child string is then ranked in a step 108. Only child strings with fitness score above a minimum fitness score is included in the initial population of gene strings to provide an updated population of gene strings for reprocessing. Child strings with low fitness scores can then be discarded. From the step 108, the GA 100 loops back to the step 104 to continue to generate new child strings based on the updated population. After many generations, the population is dominated by strings, which represent the best possible solution to the floor plan design. The evolution process continues until preset conditions are satisfied. These preset conditions are typically provided by the user in a “*.par” file, which contains conditions such as a minimum fitness score and maximum evolution time. Upon meeting the preset conditions, the final result is obtained in a step 110.

The number of possible solutions (or solution space) generated by the GA 100 is limited because floor planning only deals with fixed-size blocks. Further, wire-length minimization as a result of area minimization may not be sufficient to address path delay and routing congestion issues. To address these issues, critical paths with tight timing budgets have to be explicitly considered. However, path delay is strongly dependent on pin positioning, which depends on the placement of sub-blocks within a block. Therefore, there is a need to perform sub-block level design planning, where the sub-blocks are optimally arranged and the pins of the sub-blocks are positioned to provide minimized path delay and routing congestion.

However, the GA 100 only handles block level optimization, and the decoder in the decoding step 106 is restricted to decoding block level information.

Thus, there is a need for an IC design planning method and system having a decoder that is capable of decoding sub-block level information and explicitly consider the critical paths of sub-blocks in sub-block placement and pin positioning processes.

### SUMMARY

In accordance with a first aspect of the invention, there is disclosed an IC design planning method comprising the steps of:
providing a block placement representation being descriptive of an IC design, the IC design comprising a block having a block boundary and a plurality of sub-blocks being arranged within the block boundary, each of the plurality of sub-blocks having at least one pin and a sub-block boundary defining the area thereof, and the at least one pin of each of the plurality of sub-blocks having a positional arrangement;
positioning each of the at least one pin of each of the plurality of sub-blocks at a preliminary pin position along the block boundary of the block;
determining at least one sub-block placement parameter for each of the plurality of sub-blocks from the at least one external pin;
rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
repositioning each of the at least one pin of each of the plurality of sub-blocks at a final position, the final position being a point on the sub-block boundary of the corresponding one of the plurality of sub-blocks being nearest to the preliminary position of the corresponding one of the at least one pin thereof.

In accordance with a second aspect of the invention, there is disclosed an IC design planning method comprising the steps of:
providing a block placement representation being descriptive of an IC design, the IC design comprising a block having a block boundary and a plurality of sub-blocks being arranged within the block boundary, each of the plurality of sub-blocks having at least one external pin, at least one internal pin and a sub-block boundary defining the area thereof, and each of the at least one external pin and the at least one internal pin of each of the plurality of sub-blocks having a positional arrangement;
positioning each of the at least one external pin of each of the plurality of sub-blocks at a preliminary pin position along the block boundary of the block;
determining at least one sub-block placement parameter for each of the plurality of sub-blocks from the at least one external pin and the at least one internal pin;
rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
repositioning each of the at least one external pin of each of the plurality of sub-blocks at a final position, the final position being a point on the sub-block boundary of the corresponding one of the plurality of sub-blocks being nearest to the preliminary position of the corresponding one of the at least one external pin thereof.

In accordance with a third aspect of the invention, there is disclosed an IC design planning system comprising:
means for providing a block placement representation being descriptive of an IC design, the IC design comprising a block having a block boundary and a plurality of sub-blocks being arranged within the block boundary, each of the plurality of sub-blocks having at least one pin and a sub-block boundary defining the area thereof, and the at least one pin of each of the plurality of sub-blocks having a positional arrangement;
means for positioning each of the at least one pin of each of the plurality of sub-blocks at a preliminary pin position along the block boundary of the block;
means for determining at least one sub-block placement parameter for each of the plurality of sub-blocks from the at least one external pin;
means for rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
means for repositioning each of the at least one pin of each of the plurality of sub-blocks at a final position, the final position being a point on the sub-block boundary of the corresponding one of the plurality of sub-blocks being nearest to the preliminary position of the corresponding one of the at least one pin thereof.

### BRIEF DESCRIPTIONS OF THE DRAWING

Embodiments of the invention are described hereinafter with reference to the following drawing, in which:

FIG. 1 shows a prior art flowchart of a typical block placement using a genetic algorithm;

FIG. 2A shows a flowchart of an IC design planning method according to embodiments of the invention;

FIG. 2B shows a flowchart of a sub-block decoding process of the IC design planning method according to embodiments of the invention; and

FIG. 3A shows a diagram of blocks placement and preliminary pins placement on block boundaries;

FIG. 3B shows progressive diagrams of sub-blocks placement and critical pins placement on sub-block boundaries according to embodiments of the invention;

FIG. 4A shows a flowchart of a first sub-block placement parameters calculation according to a first embodiment of the invention;

FIG. 4B shows a flowchart of a first sub-block placement algorithm according to a first embodiment of the invention;

FIG. 5 shows an example of vertical and horizontal block partitions according to embodiments of the invention;

FIG. 6 shows a left half and a right half of the vertical block partition of FIG. 5;

FIG. 7 shows a top half and a bottom half of the horizontal block partition of FIG. 5;

FIG. 8 shows a sub-block placement in the left, right, top, and bottom halves of the block according to embodiments of the invention;

FIG. 9A shows a flowchart of a second sub-block placement parameters calculation according to a second embodiment of the invention;

FIG. 9B shows a flowchart of a second sub-block placement algorithm according to a second embodiment of the invention; and

FIG. 10 shows an example of sub-blocks placement according to a second embodiment of the invention.

### DETAILED DESCRIPTION

An IC design planning method and a system thereof having a decoder that is capable of decoding sub-block level information and explicitly considering critical paths of sub-blocks in sub-block placement and pin positioning processes for providing minimized path delay and routing congestion of an IC design are provided hereinafter. Embodiments of the invention are described with reference to the figures of the drawing, wherein like elements are identified with like reference numerals.

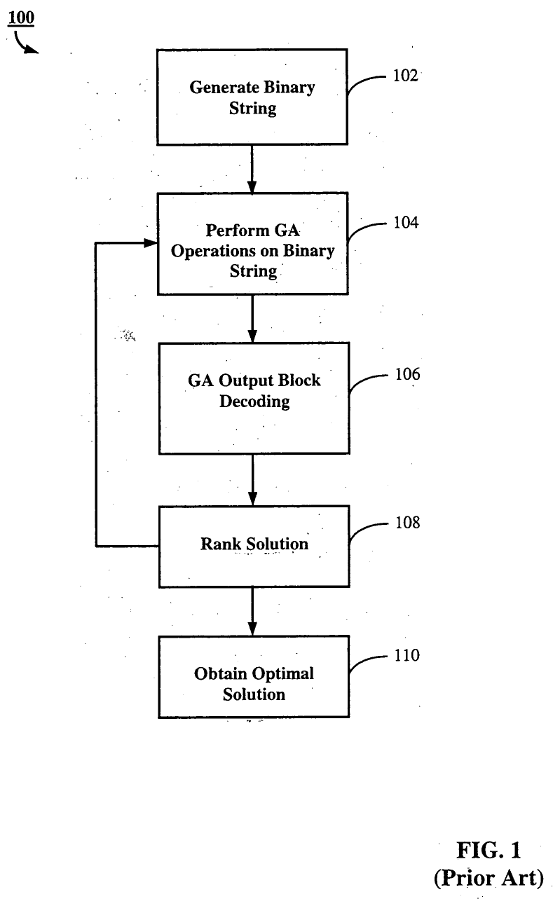

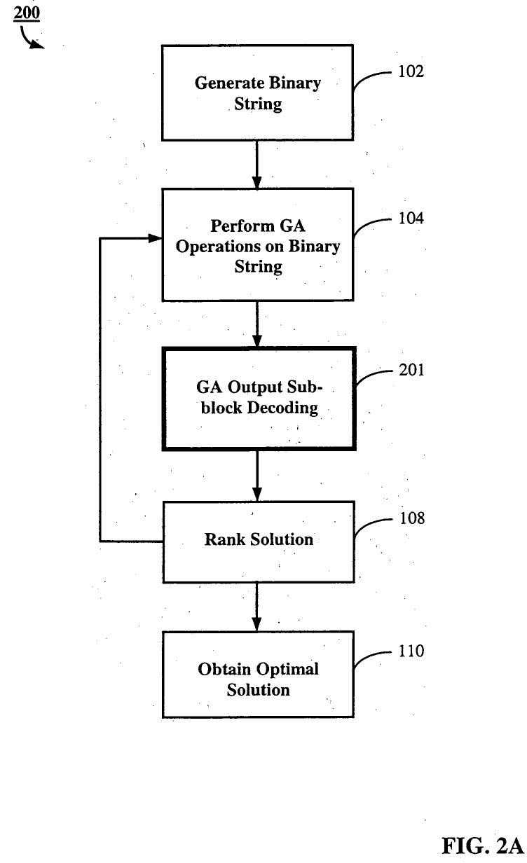

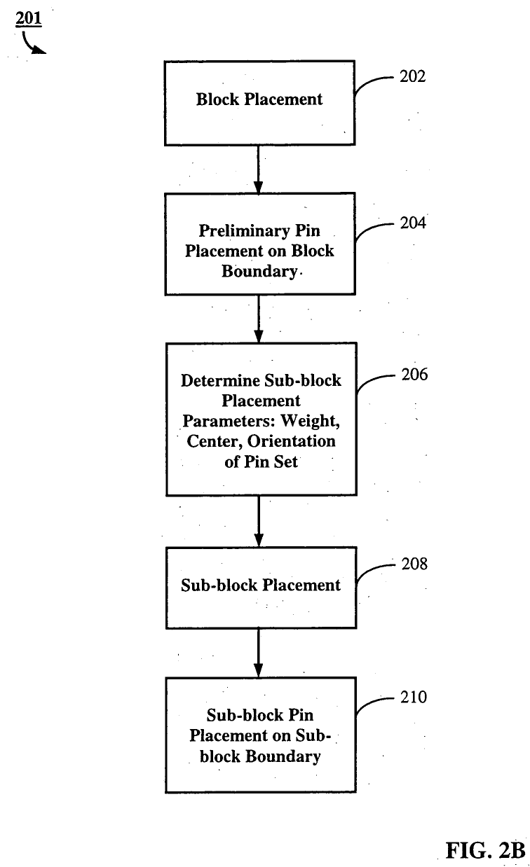

An IC design planning method 200 according to embodiments of the invention is shown in FIG. 2A. The IC design planning method 200 incorporates a number of basic steps of the GA 100 as shown in FIG. 1. These basic steps are well known to those skilled in the art. These basic steps include initial generation of gene strings for forming the initial population of gene strings for processing in a step 102 and using operators such as crossover and mutation on the gene strings to provide a new generation of child strings derived from the first generation in a step 104. The fitness value, determined in a process 201 described in further details hereinafter, is then ranked in a step 108. Child strings with low fitness values are generally discarded while those with high fitness values are introduced into the initial population to provide an updated population for reprocessing. After many evolutions, an optimal solution is obtained in a step 110.

In the IC design planning method 200 according to the embodiments of the invention, the evaluation or block decoding step 106 of GA 100 is substituted by a sub-block decoding process 201 that is capable of decoding sub-block information. The invention and the embodiments thereof described hereinafter, relates to a decoding system for generating optimized sub-block placements from a given initial block placement. The decoding system is primarily for use by an optimization algorithm, for example, the GA.

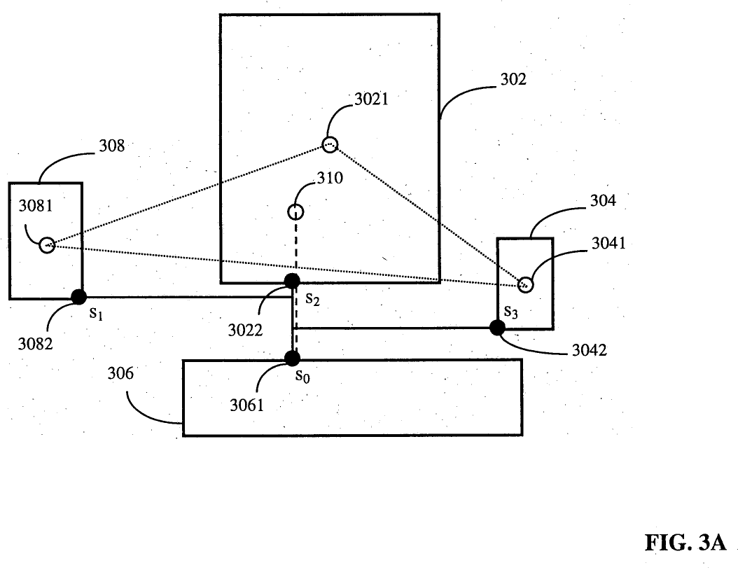

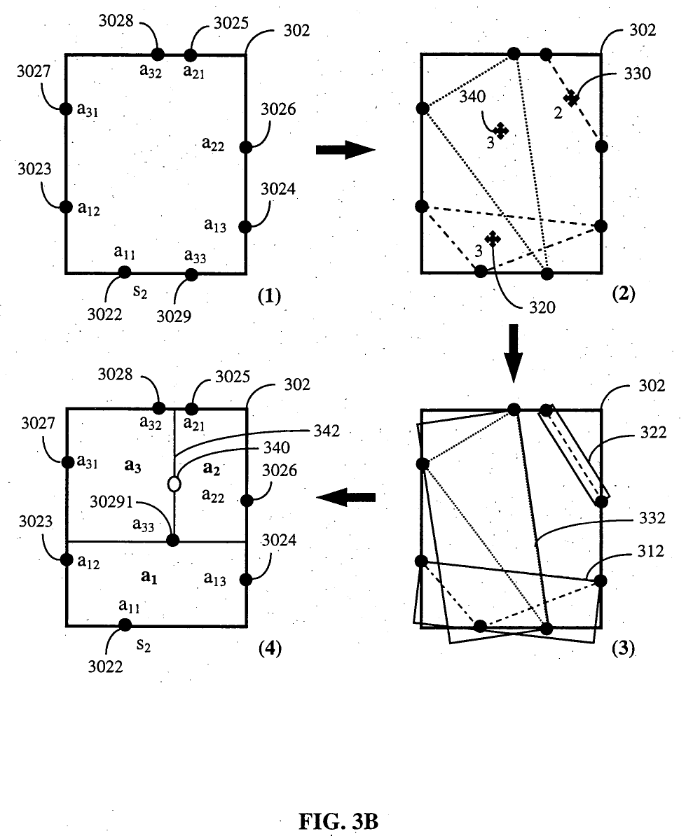

The sub-block decoding process 201 according to the embodiments of the invention is shown in FIG. 2B. In a step 202, block placement of a new child string generated by the GA in the step 104 is performed. An example of such a block placement is shown in FIG. 3A. For ease of understanding, only four rectangular blocks (302, 304, 306, and 308) are shown while, typically, there may be tens of such blocks in an IC design described by a block placement representation generated by the GA. In the example, block 302 is placed above block 306. Blocks 304 and 308 are placed to the right and left side of block 302, respectively, above block 306 as shown in FIG. 3A.

Each of the blocks 302, 304, and 308 typically comprises of many sub-blocks. Further, each block may have many critical and non-critical pins. Critical pins are pins that are part of a path in the IC design constrained by a timing budget and typically termed as a critical path. In contrast, non-critical pins are pins that are part of a non-critical path in the IC design, a path without timing budget constraint. The critical and non-critical pins are further referred to as either external or internal critical and non-critical pins depending on the path. If the net connects sub-blocks of different blocks (i.e. external net), the critical and non-critical pins are referred to as external critical and non-critical pins, respectively. If a path connects sub-blocks within the same block (i.e. internal paths), the critical and non-critical pins are referred to as internal critical and non-critical pins, respectively.

The next step in the sub-block decoding process 201 is to compute a preliminary pin position for each external pin in the IC design in a step 204. Typically, the net comprises of one source pin, s₀, and p sink pins, {s₁, . . . , sₚ}. The preliminary pin position calculation seeks to provide the ideal pin position for each external pin for minimizing path delay and routing congestion of each external net. In the example as shown in FIG. 3A, an external net with the source pin s₀ at block 306 and sink pins {s₁, s₂, s₃} at blocks 308, 302 and 304, respectively, is assumed. The preliminary pin positions of the external pins of the external net {s₀, s₁, s₂, s₃} are determined as follows with reference to FIG. 3A:
(1) Initially assume that the positions of the sink pins {s₁, s₂, s₃} are located at the center of the respective blocks, and each position is denoted with an (x, y) coordinate. Thus, for block 308, the position of sink pin s₁ is located at the center 3081 of block 308 having an (x₁, y₁) coordinate. For block 302, the position of sink pin s₂ is located at the center 3021 of block 302 having an (x₂, y₂) coordinate. Similarly, for block 304, the position of sink pin s₃ is located at the center 3041 of block 304 having an (x₃, y₃) coordinate.
(2) Compute the center of mass of sink pins {s₁, s₂, s₃} assuming each sink pin has equal weight. The center of mass of sink pins {s₁, s₂, s₃} is computed by finding an average (x, y) coordinate of the coordinates of sink pins {s₁, s₂, s₃}. In the example, the center of mass of sink pins {s₁, s₂, s₃} is at location 310.
(3) The preliminary pin position of source s₀ at block 306 is determined by the shortest distance from the center of mass of sink pins {s₁, s₂, s₃} 310 to a position on the boundary of block 306. In the example, the location of source pin so is located at 3061, which is vertically projected from the center of mass of sink pins {s₁, s₂, s₃}.
(4) Each of the preliminary pin positions of sink pins {s₁, s₂, s₃} is located at a position on the boundary of the respective block nearest to the preliminary pin position of the source pin s₀. Thus, the preliminary pin positions of sink pins {s₁, s₂, s₃} are located at 3082, 3022, and 3042 on the respective boundaries of blocks 308, 302, and 304.
(5) A route of the external net {s₀, s₁, s₂, s₃} is found by joining the source pin so and sink pins {s₁, s₂, s₃} together using a Steiner tree as shown in FIG. 3A.

The preliminary position of each external pin in the IC design is computed in the step 204 by following the procedure described in the foregoing.

Sub-blocks in each block of the IC design are preferably arranged or placed optimally in the block to minimized critical path delay and routing congestion. To determine how best to partition the block for placing the sub-blocks therein, sub-block placement parameters such as Weight, Center, and Orientation of a critical pin set of each sub-block in the block are computed in a step 206 and are used for sub-block placement in a subsequent step 208. A critical pin set of a sub-block contains critical pins of the sub-block.

In the step 208 of the sub-block decoding process 201, sub-block placement is performed based on Weight, Center, and Orientation of the critical pin set of each sub-block determined in the preceding step 206. The Weight is preferably used for deciding on the order of sub-block selection for placement. Generally, the sub-block with the highest Weight is deemed the most critical, since such a sub-block contains the most number of critical pins. Thus, preference is given to such a sub-block in the selection and placement step.

The Center indicates the preferred position or location of the sub-block within the block boundary. The Orientation indicates the preferred orientation (i.e. either vertical or horizontal) for the sub-block. For example, as seen in FIG. 3B(2), the Center of sub-block a₁ is at location 320, which is at the bottom portion of block 302. Thus, the preferred position to place sub-block a₁ is in the vicinity of the location 320.

Once all sub-blocks in the blocks in the IC design are placed in the step 208 of the sub-block decoding process 201, area calculation can be performed to determine the size of the layout area.

The next step in the sub-block decoding process 201 is to place the external critical pins on the boundaries of the sub-blocks in a step 210. In the preceding step 204, the preliminary pin positions for the external critical pins of block 302 are computed and are located at the positions as shown in FIG. 3B(1). In the step 208, sub-blocks a₁, a₂, and a₃ are optimally placed in the block as shown in FIG. 3B(4). Therefore, the final external critical pin placement for sub-blocks a₁, a₂, and a₃ are preferably positioned as close as possible to the preliminary pin positions computed in the step 204. In the example, as shown in FIG. 3B(4), external critical pins {a₁₁, a₁₂, a₁₃} of sub-block a₁ remain at the same preliminary pin positions {3022, 3023, 3024}. Similarly, external critical pins {a₂₁, a₂₂} of sub-block a₂ remain at the same preliminary pin positions {3025, 3026}. For sub-block a₃, external critical pins {a₃₁, a₃₂} remain at the same preliminary pin positions {3027, 3028}. However, external critical pin a₃₃ is shifted to the boundary of sub-block a₃ at position 30291, which is nearest to the position 3029 on the boundary of block 302, as shown in FIG. 3B(4).

In the step 210, once the external critical pins of all sub-blocks are placed, path delay and routing congestion of the IC design can be calculated. The performance of these calculations typically involves generating a Steiner tree for evaluating the routing congestion and for calculating path delay using the Elmore Delay Model.

The layout area calculation obtained in the step 208 and the path delay and routing congestion calculations obtained in the step 210 are ranked in the step 108 of the IC design planning method 200. After a number of evolutions, a high quality solution is obtained in the step 110.

In a first embodiment of the invention, the steps 206 and 208 of the sub-block decoding process 201 are performed with regards only to external critical pins of the sub-blocks.

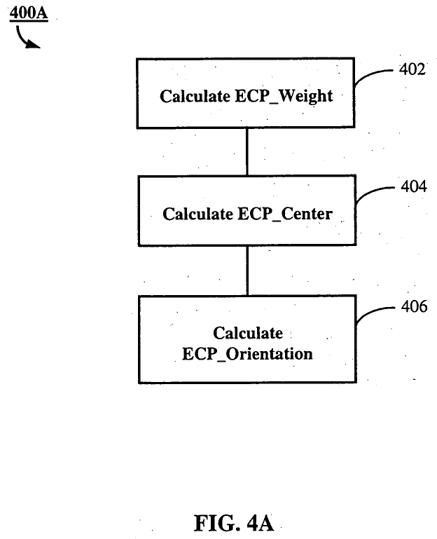

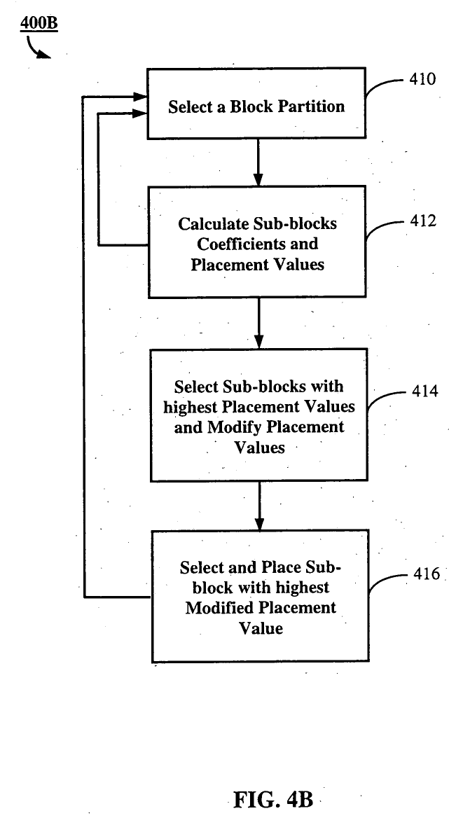

In the first embodiment, the step 206 involves calculating a first sub-block placement parameters 400A as shown in FIG. 4A. The first sub-block placement parameters include Weight, Center, and Orientation of external critical pins (ECPs) in the critical pin set of each sub-block (hereinafter referred to as ECP_Weight, ECP_Center, and ECP_Orientation, respectively).

To determine the ECP_Weight, ECP_Center, and ECP_Orientation, an ECP set for each sub-block is identified. For illustration purposes, only block 302 is discussed hereinafter with reference to FIG. 3B. Further, for ease of understanding, the block 302 is assumed to comprise of three sub-blocks a₁, a₂, and a₃. Sub-blocks a₁, a₂, and a₃ have three, two, and three ECPs, respectively, as shown in FIG. 3B(1). The positions of these ECPs are determined as described in the foregoing in the step 204. In the example, the ECP set of sub-block a₁ comprises of external critical pins a₁₁, a₁₂, and a₁₃, which are located at positions 3022, 3023, and 3024, respectively, on the boundary of block 302. Similarly, the ECP set of sub-block a₂ comprises of external critical pins a₂₁ and a₂₂, which are located at positions 3025 and 3026, respectively, on the boundary of block 302. The ECP set of sub-block a₃ comprises of external critical pins a₃₁, a₃₂, and a₃₃, which are located at positions 3027, 3028, and 3029, respectively, on the boundary of block 302.

Once the ECP set of each sub-block is identified, the ECP_Weight of each ECP set is assigned in a step 402. Preferably, the ECP_Weight of each ECP set is the cardinality of the ECP set. Thus, the ECP_Weight of sub-blocks a₁, a₂, and a₃ are three, two, and three, respectively. Other methods of assigning weight to an ECP set can also be employed. For example, the ECP_Weight of each ECP set can be assigned in proportion to the timing budget relating to each ECP in the ECP set.

The center of mass of each ECP set is subsequently computed in a step 404. The center of mass of each ECP set is an (x,y) coordinate based on the average (x,y) coordinates of all external critical pins in the ECP set. In the example in FIG. 3B(2), the centers of mass of ECP sets of sub-blocks a₁, a₂, and a₃ are located at positions 320, 330, and 340, respectively.

The orientation (i.e. either vertical or horizontal) of each sub-block is preferably determined by the orientation of the corresponding ECP set of the sub-block. To determine the orientation of each ECP set, a rectangle of minimum area enclosing each ECP in the ECP set is drawn in a step 406. In the example, rectangles 312, 322, and 332 are drawn for ECP set of sub-blocks a₁, a₂, and a₃, respectively, as shown in FIG. 3B(3). The ECP_Orientation of each ECP set is dependent on the angle between horizontal axis of the ECP_Center or the block and the longest side of the rectangle. If the angle is greater than π/2, the angle is preferably translated into an equivalent angle in the first Cartesian quadrant, which spans from angle zero to angle π/2. The value of ECP_Orientation is preferably normalized using the formula:
ECP_{—}Orientation=1−θ*4/π
where θ is the translated angle of the ECP set. If the angle in the first Cartesian quadrant is more than π/4, the ECP_Orientation is assigned a positive real value up to a maximum value of “1”. The larger the value the more vertical is the orientation of the ECP set, with the value “1” denoting a perfect vertical orientation. Thus, ECP_Orientations with positive values of lesser than “1” denote partially vertical orientations. However, if the angle in the first Cartesian quadrant is less then π/4, the ECP_Orientation is assigned a negative value, up to “−1”, which denotes a perfect horizontal orientation. If the angle in the first Cartesian quadrant equals to π/4, a value “0’ is assigned to the ECP_Orientation, which denotes that the orientation can be either vertical or horizontal. Thus, ECP_Orientations with negative values of greater than “−1” denote partially horizontal orientations. In the example, the ECP_Orientations of rectangles 312, 322, and 332 are calculated to have the values “−0.87” (partially horizontal orientation), “0.28” (partially vertical orientation), and “0.65” (partially vertical orientation), respectively.

For sub-blocks with empty ECP sets (i.e. sub-blocks without external critical pins), the ECP_Orientation is “0” and the ECP_Center is the center of the block. For sub-blocks with a single external critical pin in the ECP sets, the ECP_Orientation is also “0” with the ECP_Center being the center of mass of the single critical pin indicated by the coordinate of the single critical pin.

In the embodiments, other methods can also be employed to determine the orientation of the sub-blocks. The foregoing method is preferred because the rectangles and orientations thereof can be computed in linear time that is proportional to the number of external critical pins in the ECP sets by using the technique of rotating calipers, which is known in the art.

Additionally, the steps in the first sub-block placement parameters calculation are not restricted to any particular order. That is, once the ECP set of each sub-block is identified, any one of the ECP_Weight, ECP_Center, and ECP_Orientation can be determined first.

The minimum area rectangles 312, 322 and 332 as seen in FIG. 3B(3) can be considered as the ideal position and orientation of the respective sub-blocks in a block. However, sub-blocks cannot overlap and their orientations must be either horizontal or vertical. Thus, the next step, the step 208, in the sub-block decoding process 201 is to decide on the final orientation (“1” or “−1”) of the sub-blocks and the placement thereof within the block boundary so that there is no sub-block overlap.

In the step 208, a first sub-block placement algorithm 400B according to the first embodiment of the invention, as shown in FIG. 4, is used for determining the order of sub-block selection and sub-block placement in a block for minimizing interconnection lengths and routing congestion of external critical paths. In a step 410 of the first sub-block placement algorithm 400B, a block partition is selected. A block having a width, w, and a height, h, can be partitioned in two ways, namely, a vertical block partition and a horizontal block partition. For example, in the vertical block partition, block 320 is partitioned into a left half 502 and a right half 504 at a vertical line 503 as shown in FIG. 5(a). In the horizontal block partition, block 320 is partitioned into a top half 506 and a bottom half 508 by a horizontal line 507 as shown in FIG. 5(b). In the step 410, one of the block partitions is selected and a sub-block placement value is calculated for each sub-block in the block in a step 412 based on the selected block partition. Sub-block with the highest sub-block placement value is selected for sub-block placement.

In the step 412, the sub-block placement value of each sub-block in the block is calculated based on the selected block partition. If the selected block partition is a vertical block partition, the sub-block placement value is calculated as follows:
Kₚₒₛ_{_{—}}ᵥ=[((ECP_{—}Centerₓ−B_{center}_{_{—}}ₓ)/B_{width})*(3/2)+(1/4)] (1)
Kₒ_{_{—}}ᵥ=(1+ECP_{—}Orientation)² (2)
SBᵥₐₗᵤₑ_{_{—}}ᵥ=Kₚₒₛ_{_{—}}ᵥ*Kₒ_{_{—}}ᵥ (3)
where Kₚₒₛ_{_{—}}ᵥ is a vertical position coefficient of a sub-block, Kₒ_{_{—}}ᵥ is a vertical orientation coefficient of the sub-block, SBᵥₐₗᵤₑ_{_{—}}ᵥ is the vertical sub-block placement value of the sub-block, ECP_Center_x is the x coordinate of the ECP_Center of the ECP set of the sub-block, B_{center}_{_{—}}ₓ is the x coordinate of the block center, and B_{width} is the width of the block. The components (3/2) and (1/4) in equation (1) are optional factors included to ensure that the value of Kₚₒₛ_{_{—}}ᵥ is within a preferred range of [0.25:1]. Similarly, the component “1” in equation (2) is an optional factor.

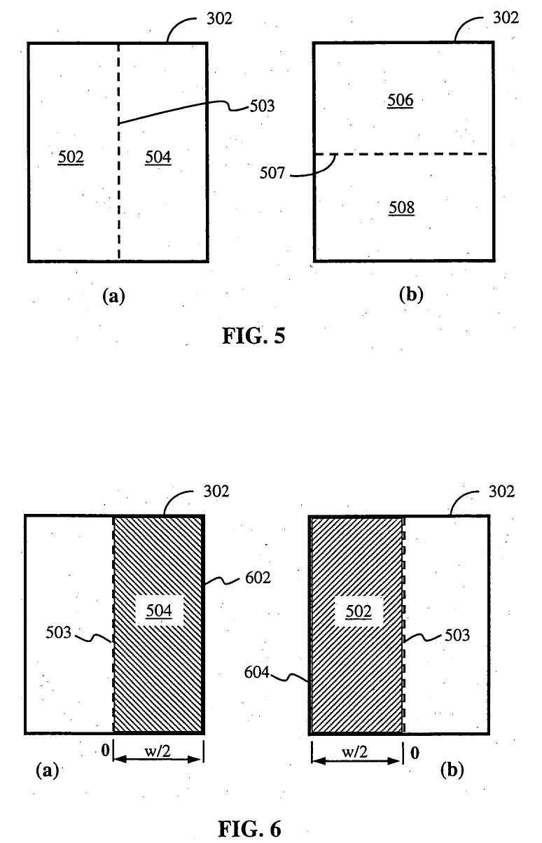

For the right half of the vertical block partition, as shown in FIG. 6(a), the vertical line 503 is considered as the starting point of the partition and is assigned a value zero. The right boundary 602 of the block is considered as the ending point of the partition. For sub-blocks with ECP_Centers located in the left half of the block, a zero value is assigned to the value Kₚₒₛ_{_{—}}ᵥ of the sub-blocks. Thus, vertical sub-block placement values SBᵥₐₗᵤₑ_{_{—}}ᵥ of these sub-blocks are zero according to equation (3). This is to ensure that sub-blocks located outside of the right half of the vertical block partition are not selected for sub-block placement in the right half of the block.

For sub-blocks with ECP_Centers located in the right half of the block, equation (1) applies. For example, if the ECP_Center of a sub-block is located on the vertical line 503, the value of Kₚₒₛ_{_{—}}ᵥ is “0.25”. If the ECP_Center of a sub-block is located on the right boundary 602 of the block, which is half the width of the block away from the vertical line 503, the value of Kₚₒₛ_{_{—}}ᵥ is “1”. Thus, according to equation (1), a sub-block with the ECP_Center located inside the right half of the vertical block partition between the vertical line 503 and the right boundary 602 of the block has a Kₚₒₛ_{_{—}}ᵥ value within the range of [0.25:1].

For the left half of the vertical block partition, as shown in FIG. 6(b), the vertical line 503 is considered as the starting point of the partition and is assigned a value zero. The left boundary 604 of the block is considered as the ending point of the partition. For sub-blocks with ECP_Centers located in the right half of the block, a zero value is assigned to the value Kₚₒₛ_{_{—}}ᵥ of the sub-blocks. Thus, vertical sub-block placement values SBᵥₐₗᵤₑ_{_{—}}ᵥ of these sub-blocks are zero according to equation (3). This is to ensure that sub-blocks located outside of the left half of the vertical block partition are not selected for sub-block placement in the left half of the block.

For sub-blocks with ECP_Centers located in the left half of the block, equation (1) applies. For example, if the ECP_Center of a sub-block is located on the vertical line 503, the value of Kₚₒₛ_{_{—}}ᵥ is “0.25”. If the ECP_Center of a sub-block is located on the left boundary 604 of the block, which is half the width of the block away from the vertical line 503, the value of Kₚₒₛ_{_{—}}ᵥ is “1”. Thus, according to equation (1), a sub-block with the ECP_Center located inside the left half of the vertical block partition between the vertical line 503 and the left boundary 604 of the block has a Kₚₒₛ_{_{—}}ᵥ value within the range of 0.25 and 1.

For both the right and left halves of the vertical block partition, the value of Kₒ_{_{—}}ᵥ according to equation (2), is within the range of 0 and 4 since the values of the ECP_Orientations of the sub-blocks are in the range of −1 and 1.

Therefore, in the step 412, if the selected block partition is the vertical block partition, two vertical sub-block placement values (one for the left half and one for the right half) for each sub-block in the block are calculated using equations (1), (2), and (3).

If the selected block partition is a horizontal block partition, the sub-block placement value is calculated as follows:
Kₚₒₛ_{_{—}}ₕ=[((ECP_{—}Center_{y}−B_{center}_{_{—}}_{y})/B_{height})*(3/2)+(1/4)] (4)
Kₒ_{_{—}}ₕ=(1−ECP_{—}Orientation)² (5)
SBᵥₐₗᵤₑ_{_{—}}ₕ=Kₚₒₛ_{_{—}}ₕ*Kₒ_{_{—}}ₕ (6)
where Kₚₒₛ_{_{—}}ₕ is a horizontal position coefficient of a sub-block, Kₒ_{_{—}}ₕ is a horizontal orientation coefficient of the sub-block, SBᵥₐₗᵤₑ_{_{—}}ₕ is the horizontal sub-block placement value of the sub-block, ECP_Center_y is the y coordinate of the ECP_Center of the ECP set of the sub-block, B_{center}_{_{—}}_{y} is the y coordinate of the block center, and B_{height} is the height of the block. The components “3/2” and “1/4” in equation (4) are factors included to ensure that the value of Kₚₒₛ_{_{—}}ₕ is within a preferred range of 0.25 and 1. Similarly, the component “1” in equation (5) is an optional factor.

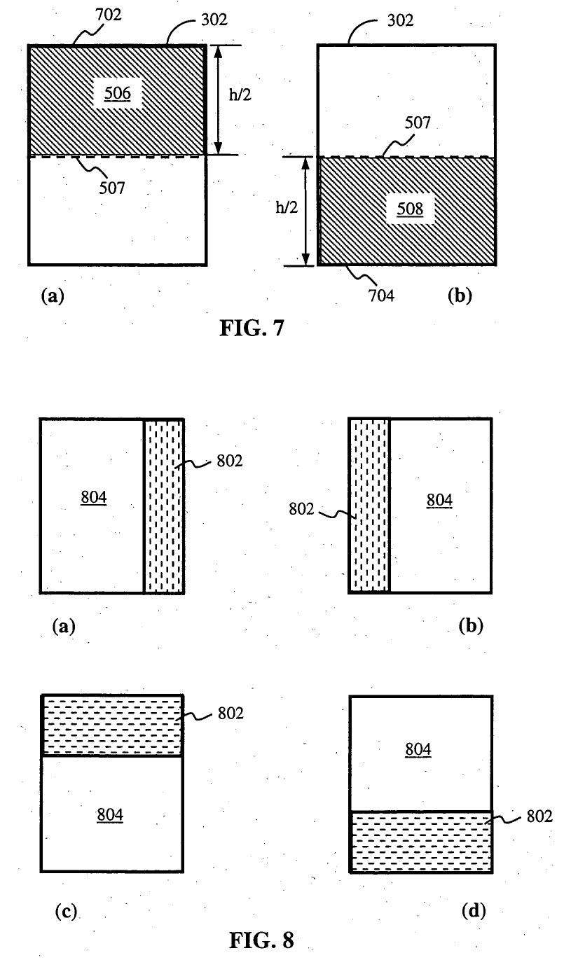

For the top half of the horizontal block partition, as shown in FIG. 7(a), the horizontal line 507 is considered as the starting point of the partition and is assigned a value zero. The top boundary 702 of the block is considered as the ending point of the partition. For sub-blocks with ECP_Centers located in the bottom half of the block, a zero value is assigned to the value Kₚₒₛ_{_{—}}ₕ of the sub-blocks. Thus, horizontal sub-block placement values SBᵥₐₗᵤₑ_{_{—}}ₕ of these sub-blocks are zero according to equation (6). This is to ensure that sub-blocks located outside of the top half of the horizontal block partition are not selected for sub-block placement in the top half of the block.

For sub-blocks with ECP_Centers located in the top half of the block, equation (4) applies. For example, if the ECP_Center of a sub-block is located on the horizontal line 507, the value of Kₚₒₛ_{_{—}}ₕ is “0.25”. If the ECP_Center of a sub-block is located on the top boundary 702 of the block, which is half the height of the block away from the horizontal line 507, the value of Kₚₒₛ_{_{—}}ₕ is “1”. Thus, according to equation (4), a sub-block with the ECP_Center located inside the top half of the horizontal block partition between the horizontal line 507 and the top boundary 702 of the block has a Kₚₒₛ_{_{—}}ₕ value within the range of 0.25 and 1.

For the bottom half of the horizontal block partition, as shown in FIG. 7(b), the horizontal line 507 is considered as the starting point of the partition and is assigned a value zero. The bottom boundary 704 of the block is considered as the ending point of the partition. For sub-blocks with ECP_Centers located in the top half of the block, a zero value is assigned to the value Kₚₒₛ_{_{—}}ₕ of the sub-blocks. Thus, horizontal sub-block placement values SBᵥₐₗᵤₑ_{_{—}}ₕ of these sub-blocks are zero according to equation (6). This is to ensure that sub-blocks located outside of the bottom half of the horizontal block partition are not selected for sub-block placement in the bottom half of the block.

For sub-blocks with ECP_Centers located in the bottom half of the block, equation (4) applies. For example, if the ECP_Center of a sub-block is located on the horizontal line 507, the value of Kₚₒₛ_{_{—}}ₕ is “0.25”. If the ECP_Center of a sub-block is located on the bottom boundary 704 of the block, which is half the height of the block away from the horizontal line 507, the value of Kₚₒₛ_{_{—}}ₕ is “1”. Thus, according to equation (4), a sub-block with the ECP_Center located inside the bottom half of the vertical block partition between the horizontal line 507 and the bottom boundary 704 of the block has a Kₚₒₛ_{_{—}}ₕ value within the range of 0.25 and 1.

For both the top and bottom halves of the horizontal block partition, the value of Kₒ_{_{—}}ₕ, according to equation (5), is within the range of 0 and 4 since the values of the ECP_Orientations of the sub-blocks are in the range of −1 and 1.

Therefore, in the step 412, if the selected block partition is the horizontal block partition, two horizontal sub-block placement values (one for the top half and one for the bottom half) for each sub-block in the block are calculated using equations (4), (5), and (6).

As calculated in the foregoing, the value of the ECP_Orientation of a sub-block is between “−1” and “1” with “−1” denoting a perfect horizontal orientation and “1” denoting a perfect vertical orientation. Thus, in equation (2), the ECP_Orientation of the sub-block is added to the factor “1” to favor sub-blocks with vertical orientation. Conversely, in equation (5), the ECP_Orientation of the sub-block is subtracted from the factor “1” to favor sub-blocks with horizontal orientation.

Steps 410 and 412 of the first sub-block placement algorithm 400B are repeated until the sub-block placement value of each sub-block is calculated for each half of the vertical and horizontal block partitions. For each half of the vertical and horizontal block partitions, the sub-blocks are ranked according to the sub-block placement values thereof. Sub-block with the highest sub-block placement value from each half of the vertical and horizontal block partitions is selected for further ranking in a step 414.

In the step 414, each of the sub-block placement values of the selected sub-blocks is further modified by the ECP_Weight of the corresponding sub-block, preferably in accordance with the following equation (7):

$${SB}_{value\_w} ← \frac{{( {SB}_{value\_SB} )}^{2}}{{\sum }_{partition}^{} ( {SB}_{value} )} \times \sqrt{{ECP\_Weight}_{SB}} \qquad ( 7 )$$

where SBᵥₐₗᵤₑ_{_{—}}_{w} is the modified sub-block placement value of a selected sub-block SB, SBᵥₐₗᵤₑ_{_{—}}_{SB} is the unmodified sub-block placement value of sub-block SB calculated in the step 412, ECP_Weight_{SB} is the ECP_Weight of the ECP set of sub-block SB calculated in the step 206, SBᵥₐₗᵤₑ is the unmodified sub-block placement value of a sub-block calculated based on the same partition as the partition from which the selected sub-block SB is selected.

Equation (7) seeks to provide a balance between the effects of high critical pin count (i.e. the ECP_Weight of the sub-block) and poor position and orientation of the sub-block SB on the modified sub-block placement value.

The sub-block with the highest modified sub-block placement value is subsequently selected for placement in a step 416 in the partition from which the sub-block is selected. For example, if a sub-block 802 has the highest modified sub-block placement value and size of area A is selected from the right half of the vertical block partition, sub-block 802 is preferably placed at the right portion of the block with a perfect vertical orientation occupying a space the size of area A of the block as shown in FIG. 8(a). The remaining block portion 804 becomes a new block for placing the remaining sub-blocks. Similarly, FIG. 8(b)-(d) show the placement of sub-block 802 if sub-block 802 is selected from the left half of the vertical block partition, top and bottom halves of the horizontal block partition, respectively. Based on the new block, steps 410 to 416 of the first sub-block placement algorithm 400B are repeated until all sub-blocks in the block are placed.

Applying the first sub-block placement algorithm 400B on block 302 as shown in FIG. 3B, sub-blocks a₁, a₂, and a₃ can be placed at the positions and orientations as shown in FIG. 3B(4).

In the first embodiment, the ECP_Center and ECP_Weight of a sub-block are determined based on the external critical pins used for block interconnections. The first embodiment proposed a block partitioning that allows the positioning of external critical pins on the sub-block boundaries so that routing congestion and interconnection lengths between sub-blocks of different blocks is minimized.

However, connection paths between ICP of sub-blocks of the same block (i.e. internal critical paths) can also contribute to path delay and routing congestion. The GA does not know the preliminary pin position of each ICP. The choice of the relative position of the sub-blocks in the block is important; therefore, sub-block placement also needs to take into account the positions of the ICP. In the example as shown in FIG. 3B(4), an ICP 340 is placed between sub-blocks a₂ and a₃. The ICP 340 can be position anywhere along the shared boundary 342 of sub-blocks a₂ and a₃ so that the interconnection length between these sub-blocks is null. It is obvious from FIG. 3B(4) that if sub-block a₃ is placed on top of sub-block a₁ and sub-block a₁ is placed on top of sub-block a₂, a non-null interconnection length between sub-blocks a₃ and a₂ is created. Thus, an objective of a second embodiment is to provide sub-block placement in a block where two interconnecting sub-blocks share a common sub-block boundary.

In the second embodiment of the invention, steps 206 and 208 of the sub-block decoding process 201 are applied to both external and internal critical pins of the sub-blocks.

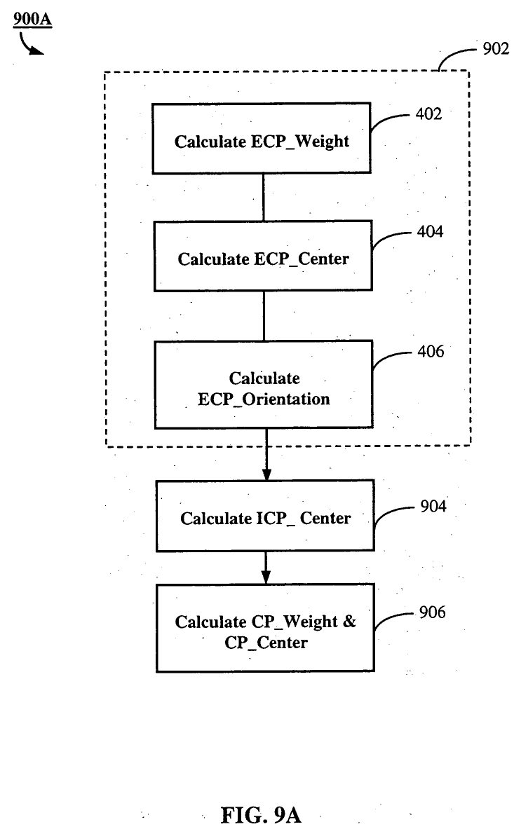

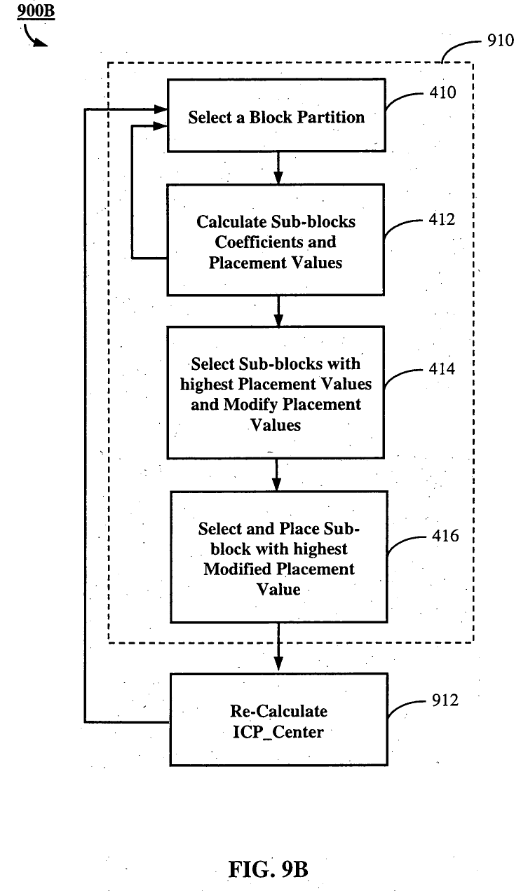

In the second embodiment, step 206 involves calculating a second sub-block placement parameters 900A as shown in FIG. 9A. The second sub-block placement parameters 900A include the first sub-block placement parameters, a center of mass of internal critical pin (ICP) set (i.e. ICP_Center) of each sub-block, a new weight of critical pin set (i.e. CP_Weight) of each sub-block, and a new center of mass of critical pin set (i.e. CP_Center) of each sub-block. Thus, the steps in the first sub-block placement parameters calculation 400A according to the first embodiment of the invention as shown in FIG. 4A are incorporated herein.

In a step 902 of the second sub-block placement parameters calculation 900A, the ECP_Weight, ECP_Center, and ECP_Orientation of each sub-block are calculated as described in the foregoing in the first embodiment with reference to FIG. 4A.

In a step 904 of the second sub-block placement parameters calculation 900A, ICP_Center of each sub-block having at least one ICP is calculated. The ICP_Center of a sub-block SB is the center of mass of all sub-blocks in a block that sub-block SB connects to. Generally, the ICP_Center of a sub-block SBi is given by:
ICP_Center_{SBi}=Center of mass of {(ECP_Center_{SB0}, Mass_{SB0}), . . . , (ECP_Center_{SBn-1}, Mass_{SBn-1})} (8)
where Mass represents the number of interconnections a sub-block SBn has with sub-block SBi.

For example, if a sub-block SB is connected to sub-block SB0 with two connection paths, sub-block SB1 with three connection paths, and sub-block SB2 with one connection path, the center of mass of ICP set of sub-block SB is:
for x coordinate:
   ICP_{—}Center_{SB}_{_{—x}}=[((ECP_{—}Center_{SB0}_{_{—}}ₓ)*2)+((ECP_{—}Center_{SB1}_{_{—}}ₓ)*3)+((ECP_{—}Center_{SB2}_{_{—}}ₓ)*1))]/6
and for y coordinate:
   ICP_{—}Center_{SB}_{_{—}}_{y}=[((ECP_{—}Center_{SB0}_{_{—}}_{y})*2)+((ECP_{—}Center_{SB1}_{_{—}}_{y})*3)+((ECP_{—}Center_{SB2}_{_{—}}_{y})*1))]/6

Once the ECP_Center and ICP_Center of each sub-block are calculated, CP_Weight and CP_Center of each sub-block are calculated in a step 906. CP_Weight and CP_Center take into account both external and internal critical pins of each sub-block.

For sub-blocks without external critical pins, the CP_Centers of the sub-blocks are the ICP_Centers of the sub-blocks, and the CP_Weights of the sub-blocks are the number of internal critical pins (ICPₙᵤₘ) of the sub-blocks. For sub-blocks with at least one external critical pin (ECPₙᵤₘ), the CP_Weights of the sub-blocks are the ECP_Weights of the sub-blocks, and the CP_Centers of the sub-blocks are calculated according to the following equation (9):
CP_{—}Center=(2*ECPₙᵤₘ*ECP_{—}Center+ICPₙᵤₘ*ICP_{—}Center)/(2*ECPₙᵤₘ+ICPₙᵤₘ) (9)

The factor “2” in equation (9) is an arbitrary weight for biasing the CP_Center towards the ECP_Center to give priority to external critical paths. Thus, other similar weights can also be used in equation (9).

Having obtained the values of CP_Center, CP_Weight, and ECP_Orientation for all sub-blocks in the block, the sub-blocks are selected for placement in steps 910 and 912 of a second sub-block placement algorithm 900B according to the second embodiment of the invention, as shown in FIG. 9B. The second sub-block placement algorithm 900B selects one sub-block at a time and performs sub-block placement in a block for minimizing both interconnection lengths of external and internal critical paths. However, in the second embodiment, internal critical paths are considered as less important when compared with external critical paths. Thus, priority remains on the optimization of sub-block placement with regards to external critical pins.

Step 910 of the second sub-block placement algorithm 900B comprises of steps 410 to 416 of the first sub-block placement algorithm 400B as described in the foregoing with reference to FIG. 4B with the following modifications. Thus, the steps in the first sub-block placement algorithm 400B according to the first embodiment of the invention as shown in FIG. 4B are incorporated herein.

The modifications are, firstly, equations (1) to (7) of the first sub-block placement algorithm 400B are replaced by the following equations (10) to (16) of the second sub-block placement algorithm 900B in the step 910 in the second embodiment, respectively:
for vertical block partition:
   Kₚₒₛ_{_{—}}ᵥ=[((CP_{—}Centerₓ−B_{center}_{_{—}}ₓ)/B_{width})*(3/2)+(1/4)] (10)
   Kₒ_{_{—}}ᵥ=(1+ECP_{—}Orientation)² (11)
   SBᵥₐₗᵤₑ_{_{—}}ᵥ=Kₚₒₛ_{_{—}}ᵥ*Kₒ_{_{—}}ᵥ (12)
for horizontal block partition:
   Kₚₒₛ_{_{—}}ₕ=[((CP_{—}Center_{y}−B_{center}_{_{—}}_{y})/B_{height})*(3/2)+(1/4)] (13)
   Kₒ_{_{—}}ₕ=(1−ECP_{—}Orientation)² (14)
   SBᵥₐₗᵤₑ_{_{—}}ₕ=Kₚₒₛ_{_{—}}ₕ*Kₒ_{_{—}}ₕ (15)
sub-block placement value modified by CP_Weight:

$${SB}_{value\_w} ← \frac{{( {SB}_{value\_SB} )}^{2}}{{\sum }_{partition}^{} ( {SB}_{value} )} \times \sqrt{{CP\_Weight}_{SB}} \qquad ( 16 )$$

Secondly, once a sub-block is selected and placed in the step 416 of FIG. 9B, the CP_Centers of the remaining sub-blocks without external critical pins that are connected to the placed sub-block are recalculated in a step 912 before reverting to the step 410 to select and place the next sub-block. The performance of step 912 is preferred in order to take into account the final placement of the placed sub-block.

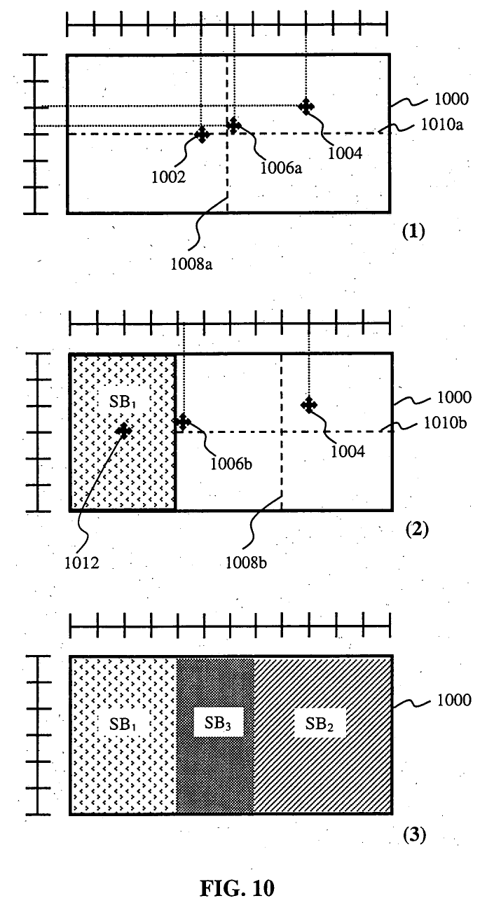

Steps 206 and 208 of the sub-block decoding process 201 according to the second embodiment of the invention are hereinafter further described with reference to FIG. 10 as an example.

In an example, a block 1000, having width of 12 units and height of six units as shown in FIG. 10, comprises of three sub-blocks SB₁, SB₂, and SB₃. Sub-block SB₁ has two external critical pins (i.e. ECPₙᵤₘ=2) and a vertical orientation of “1” (i.e. ECP_Orientation=1). Sub-block SB₂ has three external critical pins (i.e. ECPₙᵤₘ=3) and a partially vertical orientation of “0.4” (i.e. ECP_Orientation=0.4). The CP_Centers of sub-blocks SB₁ and SB₂ are located respectively at 1002 and 1004 as shown in FIG. 10(1). Sub-block SB3 has an orientation of “0” (i.e. ECP_Orientation=0), which can be either a vertical or horizontal orientation, but does not have external critical pin. However, sub-block SB₃ has two internal connection paths with sub-block SB₁ (i.e. Mass=2) and one internal connection path with sub-block SB₂ (i.e. Mass=1). Thus, sub-block SB₃ has three internal critical pins (i.e. ICPₙᵤₘ=3) and sub-blocks SB₁ and SB₂ have two and one internal critical pins, respectively. The CP_Center of sub-block SB₃ is the center of mass of CP_Center_{SB1} and CP_Center_{SB2}. Using equations (8) and (9), the CP_Center_{SB3} of sub-block SB₃ can be calculated and it is located at 1006a as shown in FIG. 10(1).

Applying a vertical block partition on block 1000, sub-block SB₁ is the only sub-block in the left half of the vertical line 1008a. Sub-block SB1 is located one unit from the vertical line 1008a. Thus, the position and orientation coefficients and sub-block placement value of sub-block SB₁ are calculated as follows using equations (10), (11), and (12) respectively:
Kₚₒₛ_{_{—}}ᵥ_{_{—}}_{SB1}=(1/12)*(3/2)+(1/4)=3/8
Kₒ_{_{—}}ᵥ_{_{—}}_{SB1}=(1+1)²=4
SB₁_{_{—}}ᵥₐₗᵤₑ_{_{—}}ᵥ=1.5

Sub-blocks SB₂ and SB₃ are located in the right half of the vertical block partition, which are three units and 1/3 unit from the vertical line 1008a, respectively. Thus, the position and orientation coefficients and sub-block placements values of sub-blocks SB₂ and SB₃ are as follow:
Kₚₒₛ_{_{—}}ᵥ_{_{—}}_{SB2}=(3/12)*(3/2)+(1/4)=5/8
Kₒ_{_{—}}ᵥ_{_{—}}_{SB2}=(1+0.4)²=1.96
SB₂_{_{—}}ᵥₐₗᵤₑ_{_{—}}ᵥ=1.3
Kₚₒₛ_{_{—}}ᵥ_{_{—}}_{SB3}=(1/36)*(3/2)+(1/4)=7/24
K₀_{_{—}}ᵥ_{_{—}}_{SB3}=(1+0)²=1
SB₃_{_{—}}ᵥₐₗᵤₑ_{_{—}}ᵥ=0.3

From the foregoing calculations, it is obvious that the choice for the left half of the vertical block partition is sub-block SB₁. Thus, using equation (16), the modified sub-placement value of sub-block SB₁ is:
SB₁_{_{—}}ᵥₐₗᵤₑ_{_{—}}_{w}=[(1.5)²/1.5]*√2=2.1

In the right half of the vertical block partition, sub-block SB2 has the highest sub-block placement value. Thus, using equation (16), the modified sub-block placement value of sub-block SB2 is:
SB₂_{_{—}}ᵥₐₗᵤₑ_{_{—}}_{w}=[(1.3)²/(1.3+0.3]*√3=1.8

Applying a horizontal block partition on block 1000, all sub-blocks SB₁, SB₂ and SB₃ are located in the top half of the horizontal block partition as shown in FIG. 10(1). Sub-blocks SB1, SB2, and SB3 are respectively located zero, one, and 1/3 unit from the horizontal line 1010a as shown in FIG. 10(1). Thus, using equations (13) to (15), the position and orientation coefficients and sub-block placement values of these sub-blocks are:
Kₚₒₛ_{_{—}}ₕ_{_{—SB1}}=(0/6)*(3/2)+(1/4)=1/4
Kₒ_{_{—}}ₕ_{_{—}}_{SB1}=(1−1)²=0
SB₁_{_{—}}ᵥₐₗᵤₑ_{_{—}}ₕ=0
Kₚₒₛ_{_{—}}ₕ_{_{—}}_{SB2}=(1/6)*(3/2)+(1/4)=1/2
Kₒ_{_{—}}ₕ_{_{—}}_{SB2}=(1−0.4)²=0.36
SB₂_{_{—}}ᵥₐₗᵤₑ_{_{—}}ₕ=0.18
Kₚₒₛ_{_{—}}ₕ_{_{—}}_{SB3}=(1/12)*(3/2)+(1/4)=3/8
Kₒ_{_{—}}ₕ_{_{—}}_{SB3}=(1−0)²=1
SB₃_{_{—}}ᵥₐₗᵤₑ_{_{—}}ₕ=0.375

Clearly, sub-block SB₃ yields the highest sub-block placement value and its modified sub-block placement value is:
SB₃_{_{—}}ᵥₐₗᵤₑ_{_{—}}_{w}=[(0.375)²/(0+0.18+0.375]*√3=0.44

The modified sub-block placement value of sub-block SB₂ from the right half of the vertical block partition is greater than the modified sub-block placement value of sub-block SB₃ from the top half of the horizontal block partition. Therefore, sub-block SB₂ is selected for placement in the right half of the block 1000 in the vertical block partition, as shown in FIG. 10(2). The area occupied is dependant on the area size of sub-block SB₂. In the example, sub-block SB₂ is assumed to have an area of 24 units². Thus, the remaining 48 units² are used for placing the remaining sub-blocks SB₂ and SB₃.

As seen in FIG. 10(2), the center of the placed sub-block SB₁ is fixed at location 1012. Thus, in the subsequent sub-block selection in accordance with step 912 of the second sub-block placement algorithm 900B, CP_Centers of sub-blocks without external critical pins are recalculated due to the new location of the center of the placed sub-block SB₁. In the example, sub-block SB₃ is the only sub-block without external critical pins. Thus, using equation (9), the CP_Center of sub-block SB₃ is calculated to located at 1006b which is 3.66 units from the vertical line 1008b and 1/3 unit from the horizontal line 1010b as shown in FIG. 10(2).

Repeating the calculations and placement steps described in the foregoing, the final placement of sub-blocks SB₁, SB₂, and SB₃ in the block 1000 is as shown in FIG. 10(3).

The IC design planning method 200 described in the foregoing according to the embodiments of the invention can be implemented using an IC design planning system comprising means for performing steps 102, 104, 201, 108, and 110 of FIG. 2A.

In the foregoing manner, an IC design planning method and a system thereof having a decoder that is capable of decoding sub-block level information and explicitly considering critical paths of sub-blocks in sub-block placement and pin positioning processes are described according to the embodiments of the invention for optimizing path delay and routing congestion. It will be apparent to one skilled in the art in view of this disclosure that numerous changes, modifications and combinations can be made without departing from the scope and spirit of the invention. For example, the IC design planning method is not restricted to any specific GA.

1. An IC design planning method comprising the steps of:
providing a block placement representation being descriptive of an IC design, the IC design comprising a block having a block boundary and a plurality of sub-blocks being arranged within the block boundary, each of the plurality of sub-blocks having at least one pin and a sub-block boundary defining the area thereof, and the at least one pin of each of the plurality of sub-blocks having a positional arrangement;
positioning each of the at least one pin of each of the plurality of sub-blocks at a preliminary pin position along the block boundary of the block;
determining at least one sub-block placement parameter for each of the plurality of sub-blocks from the at least one external pin;
rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
repositioning each of the at least one pin of each of the plurality of sub-blocks at a final position, the final position being a point on the sub-block boundary of the corresponding one of the plurality of sub-blocks being nearest to the preliminary position of the corresponding one of the at least one pin thereof.

2. The method as in claim 1, the step of providing the block placement representation comprising the step of providing the block placement representation generated by an optimization algorithm applied to the IC design.

3. The method as in claim 1, the step of providing the block placement representation comprising the step of providing the block placement representation generated by a genetic algorithm applied to the IC design.

4. The method as in claim 1, the step of positioning each of the at least one pin of each sub-block at a preliminary pin position along the block boundary of the block comprising the steps of:
obtaining a net of the IC design, the net being descriptive of at least one electrical path and signal passage thereon between one source pin and at least one sink pin, the source pin being one of the at least one pin of one of the plurality of sub-blocks and each of the at least one sink pin being one of the at least one pin of one of the plurality of sub-blocks;
finding a center of mass from the at least one sink pin;
positioning the source pin to a position on the block boundary of the block having the shortest distance from the center of mass of the at least one sink pin; and
positioning each of the at least one sink pin at a position on the block boundary of the block having the shortest distance from the position of the source pin,
wherein the preliminary position of each of the at least one pin of each of the plurality of sub-blocks is established in response to the source pin and the at least one sink pins being positioned.

5. The method as in claim 4, the step of obtaining a net of the IC design comprising the step of identifying at least one critical pin of the IC design, each of the at least one critical pin being associated with one of the at least one electrical path having a specific timing budget.

6. The method as in claim 1, the step of determining at least one sub-block placement parameter comprising the step of:
determining at least one of the orientation, the center of mass and the weight of the at least one pin of the corresponding one of the plurality of sub-blocks obtained from the positional arrangement thereof to thereby determine the at least one sub-block placement parameter of one of the plurality of sub-blocks therefrom.

7. The method as in claim 6, the step of determining at least one of the orientation, the center of mass and the weight of the at least one pin of the corresponding one of the plurality of sub-blocks obtained from the positional arrangement thereof comprising the step of:
determining the weight of the at least one pin from the quantity of the at least one pin of the corresponding one of the plurality of sub-blocks.

8. The method as in claim 7, the step of determining the weight of the at least one pin from the quantity of the at least one pin of the corresponding one of the plurality of sub-blocks comprising the step of determining the weight of the at least one critical pin from the quantity of the at least one critical pin of the corresponding one of the plurality of sub-blocks, each of the at least one critical pin being associated with an electrical path having a specific timing budget, the electrical path being described in a net of the IC design.

9. The method as in claim 6, the step of determining at least one of the orientation, the center of mass and the weight of the at least one pin of the corresponding one of the plurality of sub-blocks obtained from the positional arrangement thereof comprising the steps of:
bounding the at least one pin of each of the plurality of sub-blocks with a rectangle having an area, wherein the area of the rectangle being dimensioned for bounding the at least one pin of each of the plurality of sub-blocks is minimised; and
determining the angle between the longest side of the rectangle of each of the plurality of sub-blocks and the horizontal axis of the block to thereby determine the orientation of the at least one pin of the corresponding one of the plurality of sub-blocks, and the orientation of the at least one pin being one of horizontal, partially horizontal, vertical, and partially vertical.

10. The method as in claim 1, the step of rearranging the plurality of sub-blocks within the block boundary in accordance with the determined at least one sub-block placement parameter of each of the plurality of sub-blocks comprising the step of:
determining a rearrangement sequence based on the determined at least one placement parameter of each of the plurality of sub-blocks; and
sequential altering the dimensions of one of the plurality of sub-blocks to facilitate repositioning of the corresponding one of the plurality of sub-blocks within the block boundary of the block in accordance with the rearrangement sequence.

11. The method as in claim 1, the step of rearranging the plurality of sub-blocks within the block boundary in accordance with the determined at least one sub-block placement parameter of each of the plurality of sub-blocks comprising the steps of:
selecting a block partition for the block, the block partition being one of a vertical block partition comprising a left block portion and a right block portion, and a horizontal block partition comprising a top block portion and a bottom block portion;
calculating a sub-block placement value for each of the plurality of sub-blocks based on the at least one sub-block placement parameter thereof, the sub-block placement value being algorithmically dependent upon the selected one of the top, bottom, left and right block partitions; and
selecting one of the plurality of sub-blocks for placement within the one of the top, bottom, left and right portions that the sub-block placement value of the selected one of the plurality of sub-blocks is algorithmically dependent upon, the selected one of the plurality of sub-blocks having the highest sub-block placement value.

12. An IC design planning method comprising the steps of:
providing a block placement representation being descriptive of an IC design, the IC design comprising a block having a block boundary and a plurality of sub-blocks being arranged within the block boundary, each of the plurality of sub-blocks having at least one external pin, at least one internal pin and a sub-block boundary defining the area thereof, and each of the at least one external pin and the at least one internal pin of each of the plurality of sub-blocks having a positional arrangement;
positioning each of the at least one external pin of each of the plurality of sub-blocks at a preliminary pin position along the block boundary of the block;
determining at least one sub-block placement parameter for each of the plurality of sub-blocks from the at least one external pin and the at least one internal pin;
rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
repositioning each of the at least one external pin of each of the plurality of sub-blocks at a final position, the final position being a point on the sub-block boundary of the corresponding one of the plurality of sub-blocks being nearest to the preliminary position of the corresponding one of the at least one external pin thereof.

13. The method as in claim 12, the step of providing the block placement representation comprising the step of providing the block placement representation generated by an optimization algorithm applied to the IC design.

14. The method as in claim 12, the step of providing the block placement representation comprising the step of providing the block placement representation generated by a genetic algorithm applied to the IC design.

15. The method as in claim 12, wherein the step of positioning each of the at least one external pin of each sub-block at a preliminary pin position along the block boundary of the block comprising the steps of:
obtaining a net of the IC design, the net being descriptive of at least one electrical path and signal passage thereon between one source pin and at least one sink pin, the source pin being one of the at least one external pin of one of the plurality of sub-blocks and each of the at least one sink pin being one of the at least one external pin of one of the plurality of sub-blocks;
finding a center of mass from the at least one sink pin;
positioning the source pin to a position on the block boundary of the block having the shortest distance from the center of mass of the at least one sink pin; and
positioning each of the at least one sink pin at a position on the block boundary of the block having the shortest distance from the position of the source pin,
wherein the preliminary position of each of the at least one external pin of each of the plurality of sub-blocks is established in response to the source pin and the at least one sink pins being positioned.

16. The method as in claim 15, the step of obtaining a net of the IC design comprising the step of identifying at least one critical pin of the IC design, each of the at least one critical pin being associated with one of the at least one electrical path having a specific timing budget.

17. The method as in claim 12, the step of determining at least one sub-block placement parameter comprising the step of:
determining at least one of the orientation, the center of mass and the weight of the at least one external pin and the weight of the at least one internal pin of the corresponding one of the plurality of sub-blocks obtained from the positional arrangement thereof to thereby determine the at least one sub-block placement parameter of one of the plurality of sub-blocks therefrom.

18. The method as in claim 17, the step of determining at least one of the orientation, the center of mass and the weight of the at least one external pin of the corresponding one of the plurality of sub-blocks obtained from the positional arrangement thereof comprising the step of:
determining the weight of the at least one external pin from the quantity of the at least one external pin of the corresponding one of the plurality of sub-blocks.

19. The method as in claim 18, the step of determining the weight of the at least one external pin from the quantity of the at least one external pin of the corresponding one of the plurality of sub-blocks comprising the step of determining the weight of the at least one critical pin from the quantity of the at least one critical pin of the corresponding one of the plurality of sub-blocks, each of the at least one critical pin being associated with an electrical path having a specific timing budget, the electrical path being described in a net of the IC design.

20. The method as in claim 17, the step of determining at least one of the orientation, the center of mass and the weight of the at least one external pin of the corresponding one of the plurality of sub-blocks obtained from the positional arrangement thereof comprising the steps of:
bounding the at least one external pin of each of the plurality of sub-blocks with a rectangle having an area, wherein the area of the rectangle being dimensioned for bounding the at least one external pin of each of the plurality of sub-blocks is minimised; and
determining the angle between the longest side of the rectangle of each of the plurality of sub-blocks and the horizontal axis of the block to thereby determine the orientation of the at least one external pin of the corresponding one of the plurality of sub-blocks, and the orientation of the at least one external pin being one of horizontal, partially horizontal, vertical, and partially vertical.

21. The method as in claim 12, the step of rearranging the plurality of sub-blocks within the block boundary in accordance with the determined at least one sub-block placement parameter of each of the plurality of sub-blocks comprising the step of:
determining a rearrangement sequence based on the determined at least one placement parameter of each of the plurality of sub-blocks; and
sequential altering the dimensions of one of the plurality of sub-blocks to facilitate repositioning of the corresponding one of the plurality of sub-blocks within the block boundary of the block in accordance with the rearrangement sequence.

22. The method as in claim 12, the step of rearranging the plurality of sub-blocks within the block boundary in accordance with the determined at least one sub-block placement parameter of each of the plurality of sub-blocks comprising the steps of:
selecting a block partition for the block, the block partition being one of a vertical block partition comprising a left block portion and a right block portion, and a horizontal block partition comprising a top block portion and a bottom block portion;
calculating a sub-block placement value for each of the plurality of sub-blocks based on the at least one sub-block placement parameter thereof, the sub-block placement value being algorithmically dependent upon the selected one of the top, bottom, left and right block partitions; and
selecting one of the plurality of sub-blocks for placement within the one of the top, bottom, left and right portions that the sub-block placement value of the selected one of the plurality of sub-blocks is algorithmically dependent upon, the selected one of the plurality of sub-blocks having the highest sub-block placement value.

23. An IC design planning system comprising:
means for providing a block placement representation being descriptive of an IC design, the IC design comprising a block having a block boundary and a plurality of sub-blocks being arranged within the block boundary, each of the plurality of sub-blocks having at least one pin and a sub-block boundary defining the area thereof, and the at least one pin of each of the plurality of sub-blocks having a positional arrangement;
means for positioning each of the at least one pin of each of the plurality of sub-blocks at a preliminary pin position along the block boundary of the block;
means for determining at least one sub-block placement parameter for each of the plurality of sub-blocks from the at least one external pin;
means for rearranging the plurality of sub-blocks within the block boundary in accordance with the determined at least one sub-block placement parameter of each of the plurality of sub-blocks, wherein at least a portion of the sub-block boundary of each of the plurality of sub-blocks coincides with at least one of a portion of the block boundary of the block and a portion of the sub-block boundary of another one of the plurality of sub-blocks; and
means for repositioning each of the at least one pin of each of the plurality of sub-blocks at a final position, the final position being a point on the sub-block boundary of the corresponding one of the plurality of sub-blocks being nearest to the preliminary position of the corresponding one of the at least one pin thereof.

24. The system as in claim 23, the means for providing the block placement representation comprising the means for providing the block placement representation generated by an optimization algorithm applied to the IC design.

25. The system as in claim 23, the means for providing the block placement representation comprising the means for providing the block placement representation generated by a genetic algorithm applied to the IC design.

26. The system as in claim 23, the means for positioning each of the at least one pin of each sub-block at a preliminary pin position along the block boundary of the block comprising:
means for obtaining a net of the IC design, the net being descriptive of at least one electrical path and signal passage thereon between one source pin and at least one sink pin, the source pin being one of the at least one pin of one of the plurality of sub-blocks and each of the at least one sink pin being one of the at least one pin of one of the plurality of sub-blocks;
means for finding a center of mass from the at least one sink pin;
means for positioning the source pin to a position on the block boundary of the block having the shortest distance from the center of mass of the at least one sink pin; and
means for positioning each of the at least one sink pin at a position on the block boundary of the block having the shortest distance from the position of the source pin,
wherein the preliminary position of each of the at least one pin of each of the plurality of sub-blocks is established in response to the source pin and the at least one sink pins being positioned.

27. The system as in claim 26, the means for obtaining a net of the IC design comprising the means for identifying at least one critical pin of the IC design, each of the at least one critical pin being associated with one of the at least one electrical path having a specific timing budget.

28. The system as in claim 23, the means for determining at least one sub-block placement parameter comprising:
means for determining at least one of the orientation, the center of mass and the weight of the at least one pin of the corresponding one of the plurality of sub-blocks obtained from the positional arrangement thereof to thereby determine the at least one sub-block placement parameter of one of the plurality of sub-blocks therefrom.

29. The system as in claim 28, the means for determining at least one of the orientation, the center of mass and the weight of the at least one pin of the corresponding one of the plurality of sub-blocks obtained from the positional arrangement thereof comprising:
means for determining the weight of the at least one pin from the quantity of the at least one pin of the corresponding one of the plurality of sub-blocks.

30. The system as in claim 29, the means for determining the weight of the at least one pin from the quantity of the at least one pin of the corresponding one of the plurality of sub-blocks comprising the means for determining the weight of the at least one critical pin from the quantity of the at least one critical pin of the corresponding one of the plurality of sub-blocks, each of the at least one critical pin being associated with an electrical path having a specific timing budget, the electrical path being described in a net of the IC design.

31. The system as in claim 28, the means for determining at least one of the orientation, the center of mass and the weight of the at least one pin of the corresponding one of the plurality of sub-blocks obtained from the positional arrangement thereof comprising:
means for bounding the at least one pin of each of the plurality of sub-blocks with a rectangle having an area, wherein the area of the rectangle being dimensioned for bounding the at least one pin of each of the plurality of sub-blocks is minimised; and
means for determining the angle between the longest side of the rectangle of each of the plurality of; sub-blocks and the horizontal axis of the block to thereby determine the orientation of the at least one pin of the corresponding one of the plurality of sub-blocks, and the orientation of the at least one pin being one of horizontal, partially horizontal, vertical, and partially vertical.

32. The system as in claim 23, the means for rearranging the plurality of sub-blocks within the block boundary in accordance with the determined at least one sub-block placement parameter of each of the plurality of sub-blocks comprising:
means for determining a rearrangement sequence based on the determined at least one placement parameter of each of the plurality of sub-blocks; and
means for sequential altering the dimensions of one of the plurality of sub-blocks to facilitate repositioning of the corresponding one of the plurality of sub-blocks within the block boundary of the block in accordance with the rearrangement sequence.

33. The system as in claim 23, the means for rearranging the plurality of sub-blocks within the block boundary in accordance with the determined at least one sub-block placement parameter of each of the plurality of sub-blocks comprising:
means for selecting a block partition for the block, the block partition being one of a vertical block partition comprising a left block portion and a right block portion, and a horizontal block partition comprising a top block portion and a bottom block portion;
means for calculating a sub-block placement value for each of the plurality of sub-blocks based on the at least one sub-block placement parameter thereof, the sub-block placement value being algorithmically dependent upon the selected one of the top, bottom, left and right block partitions; and
means for selecting one of the plurality of sub-blocks for placement within the one of the top, bottom, left and right portions that the sub-block placement value of the selected one of the plurality of sub-blocks is algorithmically dependent upon, the selected one of the plurality of sub-blocks having the highest sub-block placement value.
